(19) United States
(12) Patent Application Publication
(10) Pub. No.: US 2026/0086797 A1
(43) Pub. Date: Mar. 26, 2026

(54) SOFTWARE CODE INTEGRATION TECHNIQUES IN FEDERATED SOFTWARE PLATFORMS

(71) Applicant: ATLASSIAN PTY LTD, Sydney (AU)

(72) Inventor: Marc Ross Chesworth, Sydney (AU)

(21) Appl. No.: 18/898,283

(22) Filed: Sep. 26, 2024

(51) Int. Cl. G06F 8/71

(52) U.S. Cl. CPC G06F 8/71

(57) ABSTRACT

Software code revision control in a federated software platform is provided. A source code update indication associated with a source code update identified for merger to a shared source code repository may be received. The source code update indication may comprise at least a proof of work data object generated based on one or more proof of work tests performed on the source code update in a local source code build environment. Proof of work data object may be analyzed to determine if the proof of work data object satisfies a bypass threshold based on application of one or more analytical models. In response to determining that the proof of work data object satisfies the bypass threshold, a modified source code integration workflow may be executed. The modified source code integration workflow may bypass at least one step of the baseline source code integration workflow.

### TECHNICAL FIELD

The present disclosure relates generally to software code integration; particularly to software code integration in federated software platforms.

### BACKGROUND

Software code integration is an essential aspect of software development and IT service management in a software application framework. Applicant has identified many deficiencies and problems associated with code integration process for approving and enabling code changes. Through applied effort, ingenuity, and innovation, these identified deficiencies and problems have been solved by developing solutions that are in accordance with the embodiments of the present invention, many examples of which are described in detail herein.

### BRIEF SUMMARY

In accordance with one aspect, a computer-implemented method for software code revision control in a federated software platform is provided, the computer-implemented method comprising receiving a source code update indication associated with a source code update identified for merger to a shared source code repository, wherein the source code update indication comprises at least a proof of work data object generated based on one or more proof of work tests performed on the source code update in a local source code build environment using a local build container; determining if the proof of work data object satisfies one or more bypass thresholds associated with a baseline source code integration workflow based on application of one or more analytical models; and in response to determining that the proof of work data object satisfies at least one bypass threshold of the one or more bypass thresholds, executing a modified source code integration workflow, wherein the modified source code integration workflow bypasses at least one step of the baseline source code integration workflow.

In some embodiments, receiving the source code update indication comprises receiving an updated branch of a local source code repository, wherein the local source code repository comprises a copy of the shared source code repository.

In some embodiments, the example computer-implemented method further comprises generating the local build container based on a container template of one or more container templates in response to a branching event associated with the local source code repository.

In some embodiments, the at least one step comprises a source code testing step of the baseline source code integration workflow.

In some embodiments, the proof of work data object comprises at least test results summary for the one or more proof of work tests.

In some embodiments, the proof of work data object is associated with one or more cryptographic signatures.

In some embodiments, the example computer-implemented method further comprises authenticating the proof of work data object based on the one or more cryptographic signatures.

In some embodiments, the example computer-implemented method further comprises determining the one or more bypass thresholds based on a risk level associated with the shared source code repository.

In some embodiments, the one or more analytical models comprise one or more artificial intelligence algorithms.

In some embodiments, the example computer-implemented method further comprises determining the one or more bypass thresholds based on a context associated with the source code update.

In accordance with another aspect of the present disclosure, an apparatus for software code revision control in a federated software platform is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product code for software code revision control in a federated software platform is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example software development and revision management system architecture within which at least some embodiments of the present disclosure may operate.

FIG. 2 is a block diagram of a software development and revision management apparatus structured in accordance with at least some embodiments of the present disclosure.

FIG. 3 is a block diagram of an example client computing device structured in accordance with at least some embodiments of the present disclosure.

FIG. 4A illustrates a visualization of an example data environment for software development and revision management in accordance with at least some embodiments of the present disclosure.

FIGS. 4B and 4C each illustrate a signal flow diagram of example data environment for software development and revision management in accordance with at least some embodiments of the present disclosure.

FIG. 5 is a flow chart diagram of an example process for software development and revision management in accordance with at least some embodiments of the present disclosure.

### DETAILED DESCRIPTION OF SOME EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### OVERVIEW

Modern software development teams work collaboratively but are often physically displaced relative to other teammates. Such software developers may write and store source code locally and push updates to the source code to a shared repository that stores the consolidated or merged source code. In some examples, when source code revisions are pushed to the shared repository, a “continuous integration” system may be used to automatically test the source code in one or more environments to identify errors or bugs in the source code before the source code is merged into the shared repository for ultimate deployment to a production environment.

The deployment of large, federated software platforms involve interdependent services that support a myriad of software features and applications. Indeed, some large, federated software platforms may be comprised of topologies of 1,500 or more interdependent services. Such federated software platforms are nimble, highly configurable, and enable robust collaboration and communication between users at the individual, team, and enterprise level.

However, the tremendous scale and federated nature of such a software platform adds considerable complexity to any process for adding to or otherwise updating its underlying source code. For example, as dozens of developers work in parallel to independently update source code branches, such updates might produce hundreds or even thousands of source code revisions that must be tested prior to being merged to the shared repository. This, in turn, creates several challenges including causing latency/lag in code change approvals and may even result in persistent differences between developer local source code build environments and production environments.

Various embodiments discussed herein provide a system, method, apparatus, and/or computer program product for software development and revision management that leverages a “proof of work” framework to streamline code integration, and more particularly, to streamline the integration of code changes associated with active pull/merge requests. Example embodiments provision a build container for building and testing source code in local source code build environment prior to source code merger operations. For example, various embodiments are configured to identify if a source code update is associated with a proof of work data object generated based on one or more proof of work tests performed with respect to the source code update in the local source code build environment.

Various other embodiments are configured to extract identified proof of work data objects via pull requests and verify the authenticity of the proof of work data objects. A proof of work data object, for example, may be associated with a pull request submitted to a continuous integration system. In some examples, one or more artificial intelligence/machine learning models may be trained to determine if a selected proof of work data object satisfies one or more bypass thresholds. Example embodiments execute modified source code integration workflows in response to determining that the selected proof of work data object satisfies at least one of the one or more bypass thresholds.

The modified source code integration workflows may comprise a version of the baseline source code integration workflow that bypasses at least one step of the baseline source code integration workflow such as, for example, a source code testing step. For example, a modified source code integration workflow may waive one or more operations that would otherwise be performed as part of the process to merge a source code update into a shared source code repository. In some embodiments, the step(s) of the source code integration workflow bypassed/waived may be based on the bypass threshold satisfied.

By bypassing a step that would otherwise be performed by the system, example embodiments are configured to reduce or eliminate latency/lag in code change approvals as well as reducing or eliminating differences between developer local source code build environments and production environments. Accordingly, embodiments of the present disclosure provide various technical improvements to the technical field of software code integration and to various technologies including software code integration systems.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” refers to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise issue tracking software applications, project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “federated software platform” refers to a complex network computing environment associated with a multitude of computing devices, applications, services, and microservices. For example, in some embodiments, a federated software platform includes a myriad of software features and applications that are supported by 1500 or more interdependent services operating within a cloud-based platform. Example federated software platforms may comprise a federated network of computing devices, and/or a plurality of database platforms (e.g., servers, hard-drives, etc.). Federated software platforms may support multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given federated software platform could support hundreds of software applications and hundreds of thousands of features. Those applications and features could be supported by thousands of services and microservices that exist in vast and ever-changing interdependent layers. Software development teams may release code updates to underlying source codes of federated software platforms that change various software services, launch new software services, change existing features of existing software applications, add new software applications, add new software application features to existing software applications, and/or the like. In some examples, federated software platforms are associated with a code integration workflow that includes one or more steps. In some examples, the one or more tests include at least testing source code updates prior to merging to a shared repository. Non-limiting example of applications and/or tools that may be included in a federated software platform, include Jira Software® by Atlassian, Inc., Jira Service Management® by Atlassian Inc., and Confluence® by Atlassian.

The term “continuous integration service” is a service provided by a continuous integration system configured to manage validation and updates to a shared source code repository. A continuous integration service may include a source code integration workflow that is executed in response to a request by a software developer to update a share source code repository. Continuous integration service provides several benefits. Such benefits include allowing software developers to integrate their code changes early and often to a shared source code repository to identify and address conflicts early rather than waiting to the end of a project to merge the work of all developers and having to work backward to identify and fix issues. While continuous integration service provides several benefits, the one or more steps/operations associated with a continuous integration service generally consume significant time and create latencies, particularly when various developers or teams are working in parallel to update or enhance the shared source code. Example embodiments, of the present disclosure provide a proof of work workflow (e.g., for use by a continuous integration system) configured to obviate at least a portion of the one or more steps/operations of a continuous integration service. Non-limiting example of continuous integration service is Bitbucket Pipelines via Bitbucket Software® by Atlassian, Inc.

The term “shared source code repository” refers to a storage location configured to store source code associated with a federated software platform that is accessible and updated by multiple software developers and software development teams. For example, a shared source code repository may store source code for at least a software application associated with a federated software platform. A shared source code repository may include multiple versions of source code files and metadata for software applications associated with the federated software platform. The metadata may comprise and/or represent a complete history with respect to the source code (e.g., one or more corresponding source code files) stored in the shared source code repository. For example, a shared source code repository may maintain metadata representing a complete history of project(s) associated with the source code, revisions to the source code (e.g., by software developers), and/or other relevant data that may be leveraged to track revisions associated with the source code. In some examples, the metadata may comprise and/or represent a partial history with respect the source code stored in the shared source code repository. Non-limiting examples of such metadata include author (e.g., software developer) of a source code update, timestamp for source code updates, device associated with the author of a source code update, software development team associated with the author and/or the shared source code repository, and/or the like. A shared source code repository may comprise one or more branches. In some embodiments, a shared source code repository may be managed by a version control system (also referred to herein as source code management system). In some embodiments, a shared source code repository may be stored via the version control system or otherwise accessible to the version control system. In some embodiments, each source code repository is associated with a repository identifier. Non-limiting example of a version control system is Bitbucket Software® by Atlassian, Inc

The terms “local source code repository”, “clone source code repository”, and “working source code repository” refer to a copy of a shared source code repository. For example, a local source code repository may be generated by copying (e.g., cloning) a shared source code repository. In some embodiments, a version control system and/or one or more components associated with a version control system may be leveraged to generate a local source code repository. In some examples, a local source code repository may comprise a duplicate of a portion of the source code maintained in the shared source code repository from which the local source code repository was copied. For example, when a developer seeks to add some feature or make a software update, a local source code repository may comprise a cloned copy of one or more software branches that correspond to one or more branches of the software stored to the shared source code repository.

A local source code repository may be associated with a client computing device associated with a software developer (or a group of software developers). In some embodiments, a local source code repository may be accessible to only a particular software developer or group of software developers. By way of non-limiting example, a local source code repository may be hosted by a client computing device or stored in the cloud. In some embodiments, such client computing device may comprise one or more applications configured for performing one or more functionalities including, but not limited to, generating local source code repository. For example, such client computing device may host a version control system client associated with and/or provided by a version control system. The version control system client may be configured for performing one or more functionalities including, but not limited to, generating local source code repositories (e.g., copying/cloning shared source code repositories) hosted by, managed by, and/or associated with the version control system. By way of example, one or more client computing devices each associated with a particular software developer (or particular group of software developers) may each host a respective version control system client such that each respective version control system client may be leveraged to generate a local source code repository (e.g., copy a shared source code repository and store the copied shared source code repository locally in the respective client computing device. In some embodiments, a user (such as a software developer) may initiate generation of a local source code repository. For example, the version control system client may be configured to generate a local source code repository in response to a source code repository request indication originating from the user.

Source code maintained in a local source code repository may be edited, modified, or otherwise revised by a software developer (or other user). For example, one or more local branches (e.g., development branches) may be generated based on the local source code repository and modified. The one or more local branches may correspond to one or more local branches of the shared source code repository. In some embodiments, a client computing device may host one or more applications configured for generating local branches based on the local source code repository (e.g., creating local branches on the client computing device) and modifying the created branch(es).

In some embodiments, a client computing device may host a version control system client that may be leveraged to generate local branch(es) based on a local source code repository and/or modify created local branch(es). For example, a version control system may be associated with and/or provide a version control system client that may be leveraged (e.g., by a software developer or other user, version control system, or other systems) to generate a local source code repository, generate one or more local branches based on the local source code repository, and/or modify the one or more local branches. A local source code repository and local source code, for example, may represent a working source code repository and working source code respectively

The terms “branching event” and “branching” refers to a computer-implemented process of generating a copy of a source code file. In some embodiments, a branching event may occur when a branch is generated based on a local source code repository such as, for example, when a branch of a local source code repository is copied/duplicated.

The term “local branch” refers to a portion of a source code maintained locally. A local branch may be generated from a copy of a shared source code repository (e.g., local source code repository) and may correspond to a branch of the shared source code repository. For example, a local branch may comprise a copy of a source code file of one or more source code files stored in the shared source code repository. In some embodiments, a source code file comprises one or more code lines of a source code. A local branch may be edited, modified, and/or otherwise revised. In some embodiments, a local branch may be stored locally on a client computing device and may be edited, modified, and/or otherwise revised by a software developer (or other user) associated with the client computing device. The revisions made to a local branch may be pulled into/merged into the corresponding branch of the shared source code repository in accordance with code integration techniques described herein. In some embodiments, a version control system and/or a component(s) of the version control system may be configured for generating a local branch and revising (e.g., editing, modifying, and/or the like) a local branch. In some embodiments, the version control system may be associated with and/or provide a version control system client that is configured for generating a local branch. The version control system, for example, may provide a version control system client configured for being hosted by a client computing device in some embodiments.

The term “source code update” refers to updates (e.g., changes, revisions, or similar terms) to source code in a source code repository (e.g., local source code repository, shared source code repository, or the like). Source code updates may be pushed to source code in a shared source code repository. In some embodiments, pushing updates to a shared source code repository may comprise merging two or more local source code revisions. In some embodiments, a source code update pushed to a shared source code repository may be associated with a proof of work data object. A source code update may also be referred to in some examples as a commit.

The term “proof of work data object” refers to a data object configured for verifying the execution of one or more proof of work tests performed on a source code update identified for merger to a shared source code repository. The one or more proof of work tests may be performed in a local environment (e.g., developer local source code build environment). In some embodiments, the one or more proof of work tests include unit test(s), integration test(s), system test(s), and/or the like. In some embodiments, the proof of work data object may comprise one or more of test results summary (e.g., pass/fail counts, coverage, metrics, and/or timestamps), static analysis results, dynamic analysis results, and/or the details of the local environment.

The term “pull request,” refers to signal, data, message (e.g., an inter-service message, intra-service message, network message, etc.), and/or computer readable instructions descriptive of a request to integrate/push a source code update, such as a source code revision originating from a local source code repository, into a shared source code repository (e.g., pushing a modified/updated branch of a local source code repository to a corresponding branch in the shared source code repository). In some examples, integrating/pushing a source code update into the shared source code repository involves review and approval by one or more users other than the software developer associated with the local source code revision (e.g., software developer who made the changes to the local copy of the source code). In some examples, accepting a pull request comprises or results in merging the source branch (e.g., updated branch) into the destination branch (e.g., corresponding branch in the share source code repository). A pull request may be displayed to one or more reviewers in a user interface. In some examples, the term “merge”, “merging”, or similar terms may refer to a computer-implemented process of combining local source code revisions (e.g., two or more sets of changes to local source code files) to generate a merged version with all the changes.

The term “source code repository request” refers to signal, data, message (e.g., an inter-service message, intra-service message, network message, etc.), and/or computer readable instructions descriptive of a request to generate a copy of a source code repository.

The term “container request” refers to signal, data, message (e.g., an inter-service message, intra-service message, network message, etc.), and/or computer readable instructions descriptive of a request for a container (e.g., a build container) for building and testing source code.

The term “unit tests” refer to tests configured to verify the behavior of individual methods and functions. Execution of a unit test may comprise performing checks on small pieces of code.

The term “integration tests” refer to tests configured to verify that multiple components behave correctly together. Execution of an integration test may comprise testing the integration of the source code with other services.

The term “repository identifier” refers to one or more items or elements by which a source code repository (e.g., shared source code repository or local source code repository) may be uniquely identified from other source code repositories. An issue document identifier may be in the form of text string(s), numerical character(s), alphabetical character(s), alphanumeric code(s), American Standard Code for information Interchange (ASCII) characters(s), and/or the like.

The term “user identifier” refers to one or more items or elements by which a user may be uniquely identified from other users. For instance, a user identifier may be configured to uniquely identify a user of a server computing system and/or an issue tracking system as described herein. A user identifier may be in the form of text string(s), numerical character(s), alphabetical character(s), alphanumeric code(s), American Standard Code for information Interchange (ASCII) characters(s), and/or the like.

The terms “input,” “indication,” “indication input,” “interaction,” “interaction input,” or the like refer to an identifiable, non-transitory occurrence that has technical significance for system hardware and/or software. In some embodiments, an interaction input may be user-generated via at least a user interface associated with a computing device, such as keystrokes, mouse movements, voice commands, and/or the like. In some embodiments, an interaction input may be application-generated (i.e., automatically and/or dynamically internally generated by an application via at least computing circuitry), such as program loading, compiling a data object, errors, and/or the like. For example, an application function may be caused by, and/or a data object may be generated in response to, a user interface interaction input and/or an internal confirmation interaction input generated by the application or associated computing device(s).

The terms “machine learning module,” “machine learning model,” “ML module(s),” “ML model(s),” artificial intelligence,” or “AI” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a large language model as defined above, or the like.

A machine learning model may be initially fit or trained on a training dataset (e.g., a set of examples used to fit the parameters of the model). The model may be trained on the training dataset using supervised or unsupervised learning. The model may be run with the training dataset and produce a result, which is then compared with a target, for each input vector in the training dataset. Based on the result of the comparison and the specific learning algorithm being used, the parameters of the model may be adjusted.

The machine learning models as described herein may make use of multiple ML engines (e.g., for analysis, transformation, and other needs). The system may train different artificial intelligence and/or machine learning (AI/ML) models for different needs and different ML-based engines. The system may generate new models (based on the gathered training data) and may evaluate their performance against the existing models. Training data may include any of the gathered information, as well as information on actions performed based on the various recommendations.

The AI/ML models may be any suitable model for the task or activity implemented by each ML-based engine. Machine learning models may be some form of neural network. The underlying AI/ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The AI/ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders, generative pre-trained transformer (GPT) model, or the like).

In various embodiments, the AI/ML models may undergo a training or learning phase before they are released into a production or runtime phase or may begin operation with models from existing systems or models. During a training or learning phase, the AI/ML models may be tuned to focus on specific variables, to reduce error margins, or to otherwise optimize their performance. The AI/ML models may initially receive input from a wide variety of data, such as the gathered data described herein. The ML models herein may undergo a second or multiple subsequent training phases for retraining the models.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

Thus, use of any such terms, as defined herein, should not be taken to limit the spirit and scope of embodiments of the present disclosure.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

Methods, apparatuses, and computer program products of the present disclosure may be embodied by any of a variety of devices. For example, the method, apparatus, and computer program product of an example embodiment may be embodied by a networked device (e.g., a federated software platform, or the like), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

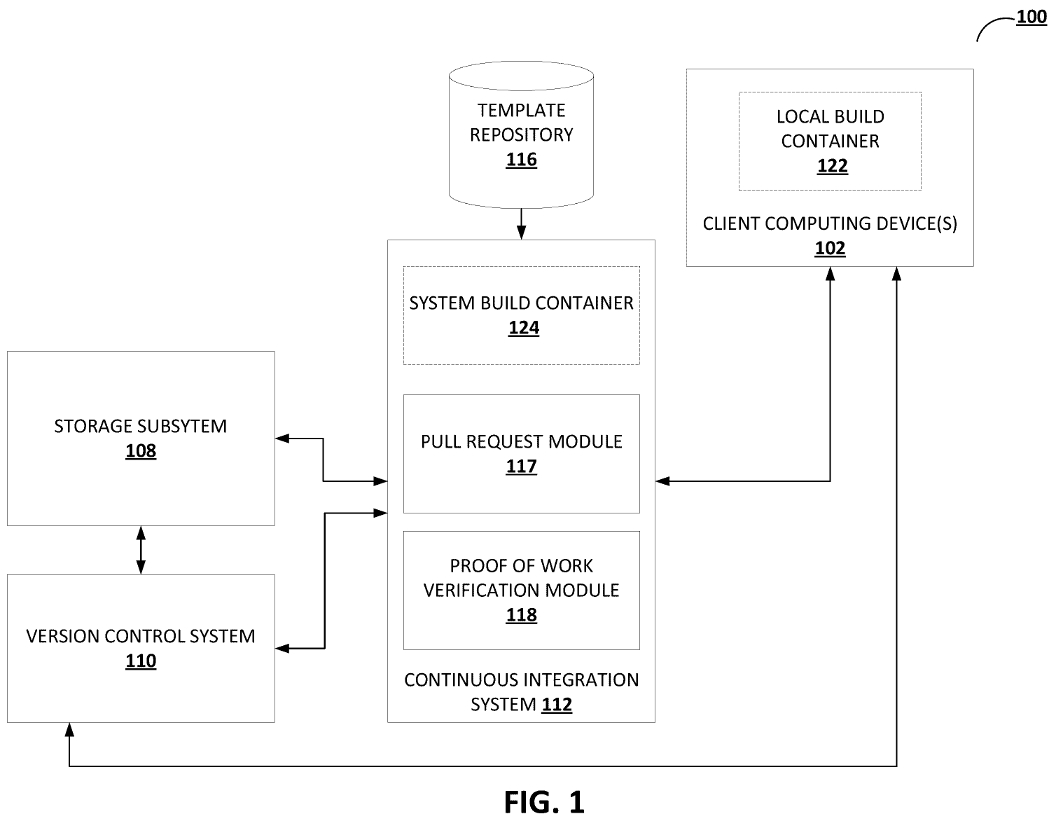

In this regard, FIG. 1 shows an example software development and revision management system architecture 100 within which embodiments of the present disclosure may operate. The depiction of the example software development and revision management system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the software development and revision management system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, and/or add aspects and/or components.

As shown in FIG. 1, the software development and revision management system architecture 100 include a continuous integration system 112 in communication with one or more client computing devices 102, and/or a version control system 110.

In some embodiments, the functions of one or more of the illustrated components in FIG. 1 may be performed by a single computing device or by multiple computing devices, which devices may be local or cloud based. It will be appreciated that the various functions performed by the version control system 110, the continuous integration system 112, and the one or more client computing devices 102 may be embodied by a single apparatus, subsystem, or system comprising one or more sets of computing hardware (e.g., processor(s) and memory) configured to perform the various functions thereof. In some embodiments, one or more of the version control system 110 and the continuous integration system 112 may be embodied by a single computing system. In some embodiments, one or more of the components of the version control system 110 and the continuous integration system 112 may be embodied by a single computing system. In some embodiments, one or more components of the version control system 110 and the continuous integration system 112 may be embodied by a client computing device 102.

Two or more of the components illustrated in the software development and revision management system architecture 100 of FIG. 1 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

The version control system 110 may be configured to store and manage source code repositories. In various embodiments, a source code repository stored by the version control system 110 may include a shared source code repository for a particular software application/software development. The shared source code repository may store source code (e.g., source code files) for the particular software application. The version control system 110 may be configured to track and manage the source code as the source code is being written and revised.

The version control system 110 may be configured to receive source code repository requests from the client computing devices 102 and/or the continuous integration system 112. In some embodiments, a source code repository request refers to signal, data, message (e.g., an inter-service message, intra-service message, network message, etc.), and/or computer readable instructions descriptive of a request to generate a copy of a source code repository. In some embodiments, the version control system 110 is configured to provide a copy of the requested source code repository to the client computing devices 102 and/or continuous integration system 112 in response to the source code repository request.

In some embodiments, the version control system 110 is associated with a version control system client configured to support source code version control. In some embodiments, a client computing device may host a version control system client. The version control system client may be configured to facilitate and/or perform one or more functionalities associated with source code version control such as generating source code repository requests, creating copies of a source code, generating branches, modifying copies of source code, pushing changes made in copies of source code to the version control system 110 to update the changes in the corresponding source code repository, retrieving metadata and/or other files from a source code repository, and/or the like.

The continuous integration system 112 (e.g., continuous integration and delivery system) may be configured to manage builds/deployments. The continuous integration system 112 may include a build container 124 used by the continuous integration to manage builds/deployments. Such build container 124 may be referred to herein as system build container 124. The continuous integration system 112 may be configured to support, facilitate, and/or enable integration of source code updates (e.g., source code revisions) by software developers into corresponding shared source code repository maintained via the version control system 110. The continuous integration system 112 may be configured to execute a source code integration workflow (e.g., a baseline source code integration workflow or a modified source code integration workflow) in response to source code update indication. The baseline source code integration workflow may include performance, by the continuous integration system 112 and using the system build container 124, of one or more tests on a source code update.

The continuous integration system 112 may include a pull request module 117. In some embodiments, The pull request module 117 may be configured to generate and manage pull requests. The pull request module 117 may be associated with a pull request user interface configured to be rendered on a display of a client computing device 102 associated with a user (e.g., such as a software developer) such that the user may initiate a pull request. For example, in some embodiments, the pull request user interface may be configured for receiving user input indicative of a pull request and/or that may be leveraged to generate a pull request. A pull request may include one or more reviewer identifiers associated with one or more reviewers selected to review an updated branch. The pull request module 117 may be configured to generate and provide notifications of a pull request to the corresponding reviewers identified in the pull request.

In some embodiments, the pull request module 117 may be configured to generate a pull request descriptor based at least in part on user input. The pull request descriptor may comprise a pull request identifier, a requesting entity identifier, originating source code repository identifier (e.g., source repository identifier), originating branch identifier (e.g., source branch identifier), destination source code repository identifier, destination branch identifier, pull request status indicator (e.g., open, modified, close, updated, and/or the like), reviewer(s) identifier, and/or other relevant data. The continuous integration system 112 (e.g., using the pull request module 117 thereof) may generate a pull request based on the pull descriptor. The continuous integration system 112 (e.g., using the pull request module 117 thereof) may be configured to transmit the pull request to client computing device(s) associated with reviewer(s) identified in the pull request.

In some embodiments, the continuous integration system 112 includes a proof of work (POW) verification module 118. In some embodiments, the continuous integration system 112 (e.g., POW verification module 118 thereof) is configured to receive source code update indications. In some embodiments, the continuous integration system 112 may receive source code update indication, directly or indirectly, from a client computing entity (e.g., associated with a developer). In some embodiments, the POW verification module 118 is configured to extract a proof of work data object associated with a source code update and verify the proof of work data object. In some embodiments, the POW verification module leverages one or more expert systems and/or one or more artificial intelligence (AI) and analysis tools to verify a proof of work data object. For example, in some embodiments, the POW verification module is associated with one or more analytical models comprising one or more AI algorithms and leverages the one or more analytical models to verify a proof of work data object. In some embodiments, verifying the proof of work data object comprises determining whether the proof of work data object satisfies one of more bypass thresholds. Alternatively or additionally, in some embodiments, verifying the proof of work data object comprises authenticating the proof of work data object based on a cryptographic signature associated with the proof or work data object.

In some embodiments, a proof of work data object is generated as a result of one or more proof of work tests performed in a local source code build environment (e.g., local build environment) on a source code update using a local build container 122. For example, in some embodiments, a proof of work data object is generated as a result of one or more tests performed in a local source code build environment on a software build that reflects changes to a source code by a particular software developer or group of software developers. The local source code build environment, for example, may be associated with the particular software developer or group of software developers. In some embodiments, the proof of work data object may be gathered passively (e.g., by background daemons).

In some embodiments, the continuous integration system 112 may be configured to provision a local build container 122 container to facilitate building and testing source code in a local source code build environment. In some embodiments, a local build container 122 may be provisioned in response to a branching event and/or source code repository cloning event. In some embodiments, a container management system (which may be associated with the continuous integration system 112) may be configured to provision the local build container 122. For example, in some embodiments, the system architecture 100 may include a container management system which may be embodied by the continuous integration system 112 or external with respect to the continuous integration system 112.

In some embodiments, the continuous integration system 112 and/or container management system may be configured to provision the local build container 122 based on container template maintained via the template repository 116. In some embodiments, a provisioned local build container 122 may replicate a production environment on which a software application is configured for being deployed.

In some embodiments, a container template may comprise a container image from which a container may be initialized and/or generated. A non-limiting example of a container image is Docker image. In some embodiments, a container template may be obtained or otherwise retrieved from the template repository 116 based on the source code repository type, build configurations, software application, type, and/or developer local environment.

In some embodiments, the continuous integration system 112 is configured to execute a modified source code integration workflow with respect to the source code update in response to determining (e.g., by the proof of work verification module 118 thereof) that the proof of work data object satisfies at least one of the one or more bypass thresholds.

In some embodiments, a modified source code integration workflow may comprise a version of a baseline source code integration workflow that bypasses at least one or more source code testing steps associated with the baseline source code integration workflow. For example, a baseline code integration workflow may include one or more source code testing steps designed to be performed by the continuous integration system 112. The one or more source code testing steps may include performing one or more tests on a source code update.

A source code testing step, for example, may define one or more source code tests to be performed on a source code update. Such one or more source code tests defined by the source code testing steps or otherwise associated with a baseline source code integration workflow may be referred to herein as CI test(s). In some embodiments, the CI test(s) may correspond to the proof of work test(s). For example, in some embodiments, the one or more tests may be identical or substantially similar to the proof of work test(s). In some embodiments, the CI test(s) and the proof of work test(s) may include at least one different test relative to each other. In some embodiments, the CI test(s) may include more or less tests relative to the proof of work test(s). Non-limiting examples of CI test(s) include, unit integration tests, system tests, performance tests, and/or the like. Non-limiting examples of proof of work test(s) include, unit integration tests, system tests, performance tests, and/or the like.

The continuous integration system 112 may include a build container 124 used to perform the source code testing steps of a baseline source code integration workflow. For example, the continuous integration system 112 may build and test in a source code build environment associated with the continuous integration system. The source code build environment associated with the continuous integration system may be referred to herein as CI source code build environment. The continuous integration system 112 may be configured to initialize the build container 124 based on a template from the template repository 116 to build and test with respect to a source code update. In some embodiments, a source code build environment and/or container (e.g., developer, system container, and/or the like) may comprise software and/or hardware on which a software application and/or a portion thereof may be compiled and/or tested.

In some embodiments, the continuous integration system 112 is configured to execute a baseline source code integration workflow in response to determining that a proof of work data object associated with a pull request does not satisfy any of the one or more bypass thresholds and/or in response to determining that the pull request is not associated with a proof of work data object. For example, the continuous integration system 112 may be configured to perform at least a portion of the CI test(s) on a source code update associated with a pull request in response to determining that a proof of work data object associated with the pull request does not satisfy any of the one or more bypass thresholds and/or in response to determining that the pull request is not associated with a source code update.

In this regard, the portion of the CI test(s) performed may be based on the bypass threshold (e.g., of one or more bypass thresholds) satisfied by the proof of work data object. For example, each bypass threshold may be associated with a particular portion of the CI test(s) such that the particular portion of the CI test(s) may be bypassed/waived for a pull request associated with a proof of work data object that satisfies the bypass threshold.

Alternatively or additionally, in some embodiments, the continuous integration system 112 (e.g., the POW verification module 118 thereof) is configured to associate a pull request and/or source code update associated with a pull request with a corresponding bypass flag (e.g., bypass indicator) in response to determining that the proof of work data object associated with a pull request satisfies at least one of the one or more bypass thresholds. Alternatively, or additionally, in some embodiments, the continuous integration system 112 (e.g., POW verification module 118 thereof) may be configured to transmit instructions to the version control system 110 and/or other system configured to direct the version control system 110 and/or the other system to associate a source code update with a corresponding bypass flag in response to determining that a proof of work data object satisfies at least one of the one or more bypass thresholds.

In some embodiments, the system architecture 100 includes a storage subsystem 108. The storage subsystem may be configured to store input data, training data, and/or the like that may be used by one or more of the other systems illustrated in FIG. 1 to perform various functionalities associated therewith. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. Additionally, the storage subsystem 108 may be configured to store one or more artificial intelligence/machine learning models.

Two or more of the components illustrated in the architecture 100 illustrated in FIG. 1 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In some embodiments, the components depicted in FIG. 1, although not required to be an integral system, may be connected via one or more networks. In some embodiments, one or more APIs may be leveraged to communicate with and/or facilitate communication between one or more of the components illustrated in the software development and revision management system architecture 100.

### Example Apparatuses of the Disclosure

Having discussed example systems in accordance with the present disclosure, example apparatuses in accordance with the present disclosure will now be described.

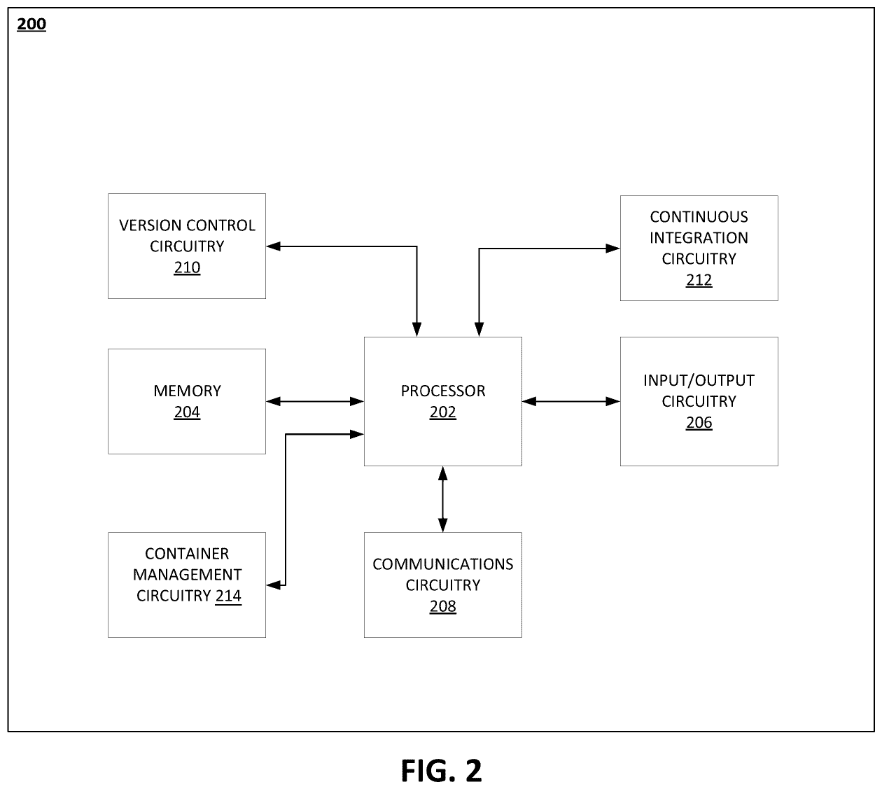

FIG. 2 illustrates a block diagram of a software development and revision management apparatus 200 in accordance with some example embodiments. For example, in some embodiments, the version control system 110, continuous integration system 112, and/or storage subsystem 108, template repository 116 (or one or more portions thereof), if embodied in a particular embodiment, may be embodied by one or more apparatuses 200. It should be noted, however, that the components, or elements illustrated in and described with respect to FIG. 2 may not be mandatory and thus one or more may be omitted in certain embodiments. Additionally, some embodiments, may include further or different components or elements beyond those illustrated in and described with respect to FIG. 2. In some embodiments, the functionality of the version control system 110, continuous integration system 112, and/or storage subsystem 108, template repository 116 or any subset thereof may be performed by a single apparatus 200 or multiple apparatuses 200. In some embodiments, the apparatus 200 may comprise one or a plurality of physical devices.

The apparatus 200 may include processor 202, memory 204, input/output circuitry 206, communications circuitry 208, version control circuitry 210, continuous integration circuitry 212, and/or container management circuitry 214. The apparatus 200 may be configured to execute the operations described herein. Although these components 202-214 are described with respect to functional limitations, it should be understood that the particular implementations necessarily include the use of particular hardware. It should also be understood that certain of these components 202-214 may include similar or common hardware. For example, two sets of circuitries may both leverage use of the same processor, network interface, storage medium, or the like to perform their associated functions, such that duplicate hardware is not required for each set of circuitrics.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus 200 includes a version control circuitry 210. The version control circuitry 210 may include hardware components, software components, and/or a combination thereof configured to, with the processor 202, memory 204, input/output circuitry 206 and/or communications circuitry 208, perform one or more functions associated with a version control system 110 (as described above with reference to FIG. 1). In some embodiments, the version control circuitry 210 may be configured to receive and/or transmit data, objects, and/or the like from and/or to one or more components of the apparatus 200, through, for example, the use of applications or APIs executed using a processor, such as the processor 202. It should also be appreciated that, in some embodiments, the version control circuitry 210 may include a separate processor, specially configured field programmable gate array (FPGA), or application specific interface circuit (ASIC) to provide or otherwise facilitate access to such data, objects, and/or the like used by one or more other components of the apparatus 200. The version control circuitry 210 may also provide for communication with other components of the apparatus, system and/or external systems via a network interface provided by the communications circuitry 208.

In some embodiments, the apparatus 200 includes a continuous integration circuitry 212. The continuous integration circuitry 212 may include hardware components, software components, and/or a combination thereof configured to, with the processor 202, memory 204, input/output circuitry 206 and/or communications circuitry 208, perform one or more functions associated with a continuous integration system 112 (as described above with reference to FIG. 1). In some embodiments, the continuous integration circuitry 212 may be configured to receive and/or transmit data, objects, and/or the like from and/or to one or more components of the apparatus 200, through, for example, the use of applications or APIs executed using a processor, such as the processor 202. It should also be appreciated that, in some embodiments, the continuous integration circuitry 212 may include a separate processor, specially configured field programmable gate array (FPGA), or application specific interface circuit (ASIC) to provide or otherwise facilitate access to such data, objects, and/or the like used by one or more other components of the apparatus 200. The continuous integration circuitry 212 may also provide for communication with other components of the apparatus, system and/or external systems via a network interface provided by the communications circuitry 208.

In some embodiments, the apparatus 200 may include a container management circuitry (not shown). The container management circuitry 214 may include hardware components, software components, and/or a combination thereof configured to, with the processor 202, memory 204, input/output circuitry 206 and/or communications circuitry 208, perform one or more functions associated with provisioning a container (e.g., local build container, system container). In some embodiments, the container management circuitry 214 may be configured to receive and/or transmit data, objects, and/or the like from and/or to one or more components of the apparatus 200, through, for example, the use of applications or APIs executed using a processor, such as the processor 202. It should also be appreciated that, in some embodiments, the container management circuitry 214 may include a separate processor, specially configured field programmable gate array (FPGA), or application specific interface circuit (ASIC) to provide or otherwise facilitate access to such data, objects, and/or the like used by one or more other components of the apparatus 200. The container management circuitry 214 may also provide for communication with other components of the apparatus, system and/or external systems via a network interface provided by the communications circuitry 208.

Additionally or alternatively, in some embodiments, two or more of the sets of circuitries embodying processor 202, memory 204, input/output circuitry 206, communications circuitry 208, version control circuitry 210, continuous integration circuitry 212, and/or container management circuitry 214 are combinable. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208, version control circuitry 210, continuous integration circuitry 212, and/or container management circuitry 214 are combined into a single module embodied in hardware, software, firmware, and/or a combination thereof. Similarly, in some embodiments, one or more of the sets of circuitry, for example, version control circuitry 210, continuous integration circuitry 212, and/or container management circuitry 214 is/are combined with the processor 202, such that the processor 202 performs one or more of the operations described above with respect to each of these sets of circuitry embodied by version control circuitry 210, continuous integration circuitry 212, and/or container management circuitry 214.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Client Computing Device

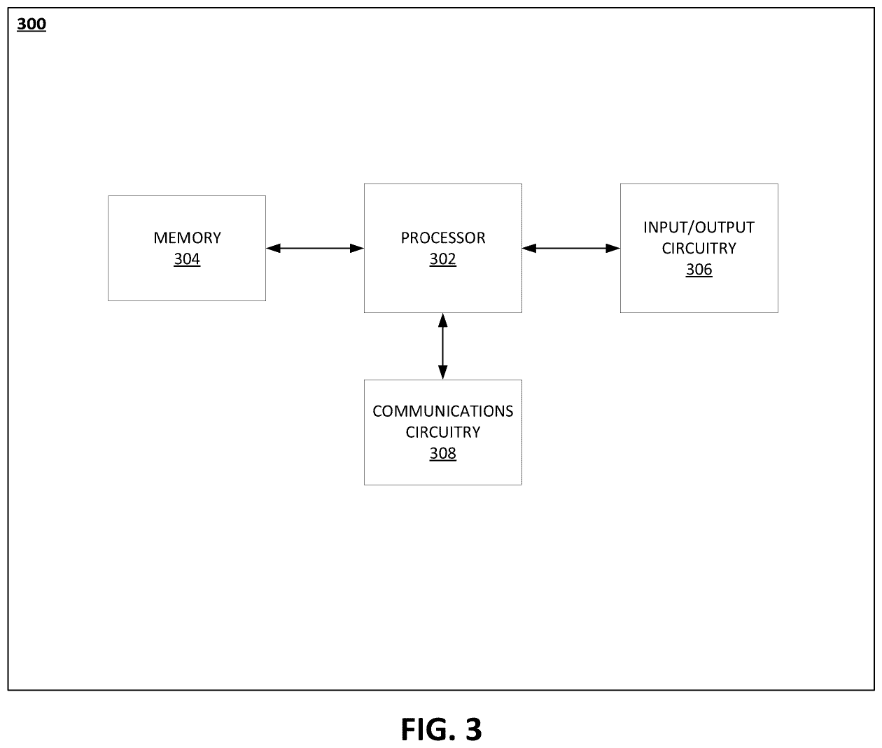

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Example Data Flows, Operations, and User Interfaces

As indicated, some embodiments of the present disclosure make important technical contributions to software code integration. In particular, systems and methods are disclosed herein that implement a specially-configured software code integration framework that uses proof of work to streamline pull/merge requests. In particular, by using proof of work to streamline pull/merge requests according to techniques disclosed herein, embodiments of the present disclosure solves the challenges associated with existing code integration systems include lagging code changes and persistent differences between developer local environment and production environment.

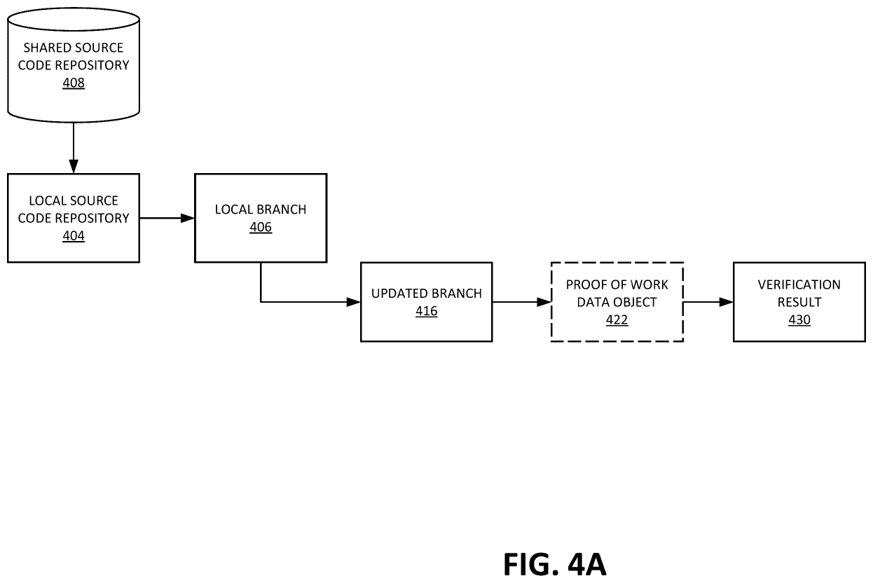

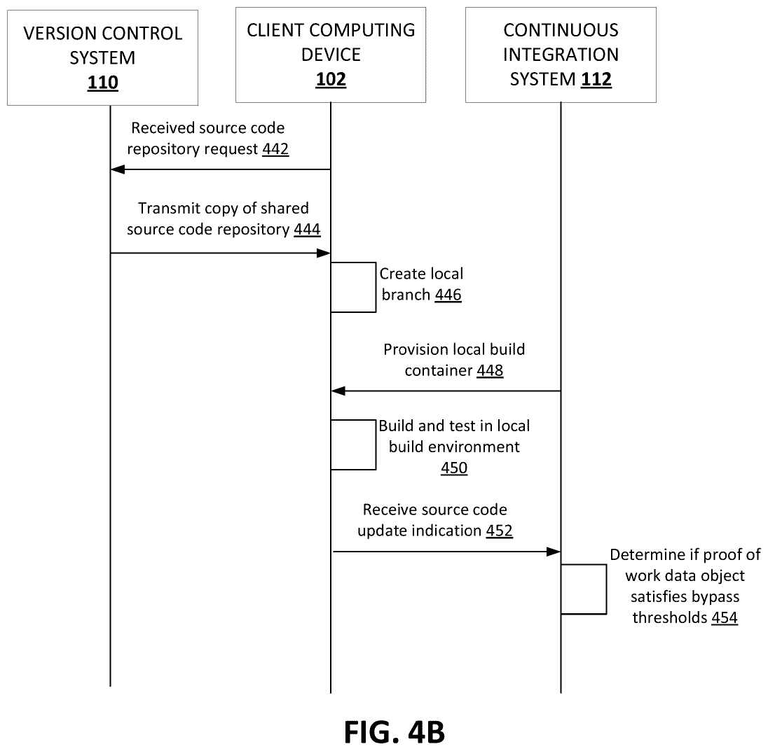

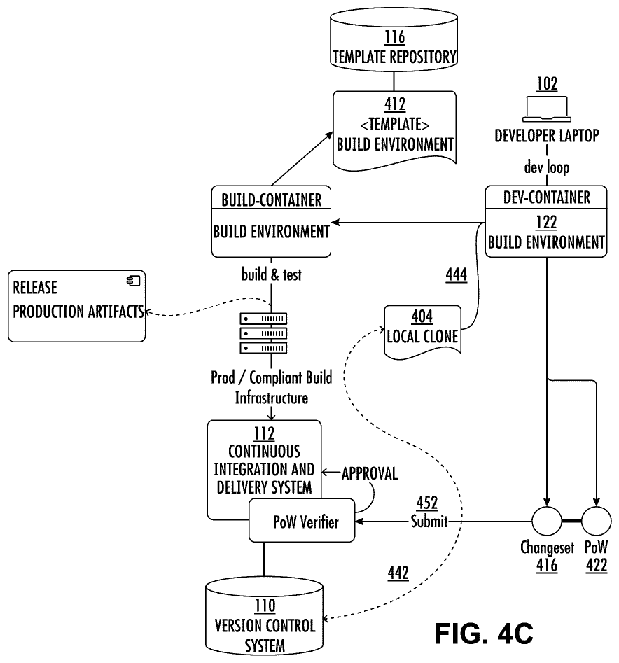

FIG. 4A illustrates a visualization of an example data environment for software development and revision management in accordance with at least some embodiments of the present disclosure. In particular, FIG. 4A illustrates a streamlined pull/merge request framework in accordance with at least some embodiments of the present disclosure.

In some embodiments, a source code update indication associated with a source code update identified for merger to a shared source repository is received. The source code update indication may be received from a client computing device, such as client computing device 102 associated with a software developer or other user. In some embodiments, the source code update indication may comprise an updated branch 416 and a proof of work data object 422 (described further below). In some embodiments, a source code update indication corresponds to a pull request. For example in some embodiments, a source code update indication may be a pull request. In some embodiments, a pull request is a computer-implemented process of pushing code changes to a source code repository. For example, the source code update indication (e.g., pull request) may indicate a request to merge an updated branch 416 originating from a local source code repository 404 to a shared source code repository 408.

The local source code repository 404 may comprise a copy of the shared source code repository 408 (e.g., a clone of the shared source code repository 408) stored locally on a client computing device. For example, the local source code repository 404 may be generated by copying (e.g., cloning) a shared source code repository 408 maintained via a version control system such as version control system 110 described above with respect to FIG. 1. In some embodiments, a version control system and/or one or more components associated with a version control system may be leveraged to generate the local source code repository. When initially generated, the local source code repository 404 may comprise a duplicate of a shared source code maintained in the shared source code repository 408 from which the local source code repository 404 was copied. A local source code repository 404 may comprise one or more local branches that correspond to one or more branches of the shared source code repository 408.

In some embodiments, the local source code repository 404 may be associated with a client computing device associated with a software developer (or a group of software developers). In some embodiments, a client computing device may comprise one or more applications configured for performing one or more functionalities including, but not limited to, generating a local source code repository, such as local source code repository 404. For example, such client computing device may host a version control system client (e.g., as described above) associated with and/or provided by a version control system such a version control system 110 described above with respect to FIG. 1.

The version control system client may be configured for performing one or more functionalities including, but not limited to, generating local source code repositories (e.g., copying/cloning shared source code repositories) hosted by, managed by, and/or associated with the version control system. By way of example, one or more client computing devices each associated with a particular software developer (or particular group of software developers) may each host a respective version control system client such that each respective version control system client may be leveraged to generate a local source code repository 404 (e.g., copy a shared source code repository 408 and store the copied shared source code repository locally such as in the respective client computing device, cloud, and/or the like for access by the particular software developer or particular group).

In some embodiments, a user (such as a software developer) may initiate generation of a local source code repository 404 using the version control system client. For example, the version control system client may be configured to generate or facilitate generation of a local source code repository 404 in response to user interaction with the version control system client and/or user input indicative of a source code repository request.

In some embodiments the shared source code repository is a storage location configured to store source code associated with a federated software platform. For example, the shared source code repository 408 may store source code for at least a software application associated with a federated software platform. A shared source code repository may include multiple versions of source code files and metadata. The metadata may comprise and/or represent a complete history with respect to the source code (e.g., one or more corresponding source code files) stored in the shared source code repository 408. For example, a shared source code repository may maintain metadata representing a complete history of project(s) associated with the source code, revisions to the source code (e.g., by software developers), and/or other relevant data that may be leveraged to track revisions associated with the source code. In some examples, the metadata may comprise and/or represent a partial history with respect the source code stored in the shared source code repository. A shared source code repository may comprise one or more branches. In some embodiments, a shared source code repository may be managed by a version control system. In some embodiments, a shared source code repository may be stored via the version control system or otherwise accessible to the version control system. In some embodiments, a source code repository may be associated with a repository identifier configured to uniquely identify the source code repository from other source code repositories.

A software developer (or other user) may generate a local branch 406 based on the local source code repository associated with the client computing device associated with the software developer and make changes to the local branch 406 to generate an updated branch 416. A local branch, such as local branch 406, may describe a portion of a source code maintained locally on a client computing device 102. A local branch, for example, may comprise a copy of a source code file (or portion thereof) of one or more source code files (e.g., one or more code lines of a source code) stored in a shared source code repository In this regard, a local branch may represent a development branch, working branch, or similar terms, that is created for being updated by a software developer.

In some embodiments, a local build container, such as local build container 122 is provisioned for a client computing device, such that a user associated with the client computing device may build and test against a source code build environment defined by the local build container. Such source code build environment defined by a local build container associated with a client computing device may be referred to herein as local source code build environment. A software developer (or other user) may perform one or more proof of work tests on a source code update, such as updated branch 416 in the source code build environment defined by the local build container provisioned for the client computing device. In some embodiments, the one or more proof of work tests include unit test(s), integration test(s), system test(s), and/or the like.

In some embodiments, a proof of work data object 422 is generated in the local source code build environment when a software developer (or other user) performs at least one of the one or more proof of work tests on a source code update, such as updated branch 416. In some embodiments, the proof of work data object 422 may be gathered passively. For example, in some embodiments, the proof of work data object may be generated using background daemons (e.g., unbeknownst to the software developer in some embodiments). In some embodiments, the proof of work data object 422 is associated with one or more cryptographic signatures when generated.

A local build container may describe a build container hosted on a client computing device or otherwise associated with a client computing device. The local build container may be configured for building, executing, and/or testing a source code corresponding to a software application and that includes or otherwise reflects revisions made locally to a source code, such as local branch 406. For example, a local build container may be leveraged to build, execute, and/or test source code that includes an updated branch, such as updated branch 416.

In some embodiments, a build container, such as a local build container, is an executable software package that includes the dependencies (e.g., code, runtime, configuration, system libraries, and/or other operating system level applications) to compile and/or execute source code corresponding to a software application. A build container, for example, may represent software instances that contain source code for a software application and its dependencies. In some embodiments, a build container may be configured for being run on any host system. A build container may be configured to run on a physical or virtual machines.

In some embodiments, the local build container is provisioned or otherwise generated based on a container template of one or more container templates. In some embodiments, the one or more container templates are stored in a template repository, such as template repository 116. In some embodiments, a local build container may be provisioned for a client computing device in response to indication of a branching event. For example, a local build container may be provisioned for a client computing device in response to a local branch, such as local branch 406, being created/generated.

In some embodiments, each container template may represent a particular source code build environment, such that a local build container provisioned for a client computing device may comprise an instance of particular container template representing a particular source code build environment. Alternatively or additionally, in some embodiments, a container template may include information for provisioning a local build container for a particular software application and/or that reflects a particular deployment environment. In some embodiments, a local build container may be provisioned for access by a client computing device 102 (e.g., associated with a software developer) and/or for being hosted by a client computing device 102.

As described above, a source code update indication may include a source code update such as updated branch 416. Additionally, the source code update indication may include a proof of work data object 422 generated when at least one of the one or more proof of work tests is performed in a local source code build environment. In some embodiments, the proof of work data object 422 is extracted from the source code update indication (e.g., pull request). In some embodiments, the proof of work data object 422 may comprise one or more of test results summary (e.g., pass/fail counts, coverage, metrics, and/or timestamps), static analysis results, dynamic analysis results, and/or the details of the local development environment.

In some embodiments, the proof of work data object is analyzed, using one or more analytical models, to determine if the proof of work data object satisfies one or more bypass thresholds associated with a baseline source code integration workflow. In some embodiments, a bypass threshold describes, comprises, and/or otherwise represents criteria for bypassing a particular step associated with the baseline source code integration workflow. In some embodiments, the one or more analytical models comprise one or more AI/ML models and/or algorithms. The proof of work data object may be provided as input to the one or more analytical models configured to analyze the input proof of work data object and generate an output that indicates which bypass threshold(s) is/are satisfied by the proof of work data object.

Additionally, in some embodiments, the proof of work data object is authenticated to verify the integrity and/or authenticity of the proof of work data object. In some embodiments, the proof of work data object is authenticated based on cryptographic signatures associated with the proof or work data object (as described above). In some embodiments, a verification result 430 may be generated based on the analysis and/or authentication of a proof of work data object. The verification result 430 may comprise data that describes if the proof of work data object was successfully authenticated and/or data that describes if the proof of work data object 422 satisfies a bypass threshold and/or the corresponding bypass thresholds satisfied.

In some embodiments, a baseline source code integration workflow is executed (e.g., by continuous integration system 112) with respect to the source code update where it is determined that the proof of work data object associated with the source code update indication (e.g., pull request) does not satisfy any of the one or more bypass thresholds and/or in the event that the source code update indication is not associated with a proof of work data object. In some embodiments, a baseline source code integration workflow comprises one or more source code testing steps as described above with respect to FIG. 1.

In some embodiments, a modified source code integration workflow is executed (e.g., by the continuous integration system 112) with respect to the source code update where it is determined that the proof of work data object associated with the source code update indication satisfies at least one of the one or more bypass thresholds. In some embodiments, a modified source code integration workflow may comprise a version of a baseline source code integration workflow that bypasses at least one or more source code testing steps associated with the baseline source code integration workflow.

In some other embodiments, the baseline source code integration workflow is executed (e.g., by continuous integration system 112) with respect to the source code update in response to determining that a proof of work data object associated with the source code update indication does not satisfy any of the one or more bypass thresholds and/or in response to determining that the source code update indication is not associated with a proof of work data object. Further, in such other embodiments, a modified source code integration workflow is executed (e.g., by the continuous integration system 112) with respect to the source code update in response to determining that the proof of work data object associated with the source code update indication satisfies at least one of the one or more bypass thresholds.

In some embodiments, in response to determining that the proof of work data object satisfies at least one of the bypass thresholds, the source code update indication is associated with a corresponding bypass flag.

FIGS. 4B and 4C each illustrate a signal flow diagram of example data environment for software development and revision management in accordance with at least some embodiments of the present disclosure. As depicted in FIG. 4B, the version control system 110 may receive 442 a source code repository request from a client computing device 102 associated with a software developer (or other user). The version control system may transmit 444 a copy of a shared source code repository (e.g., cloned source code repository 404) to the client computing device 102 in response to the source code repository request. The client computing device 102 may be caused by the software developer associated with the client computing device 102 to create 446 a local branch. A local build container 122 may be provisioned 448 for the client computing device 102 by the continuous integration system 112. The local build container 122 may be provisioned based on a container template 412 selected from one or more container templates maintained via the template repository 116.

Source code build and test 450 (including proof of work test(s)) may be performed in the local source code build environment defined by the local build container provisioned for the client computing device 102. A proof of work data object 422 may be generated in the local source code build environment based on the proof of work test(s) performed in the local source code build environment defined by the local build container 122. The continuous integration system 112 may receive 452 a source code update indication (e.g., pull request) from the client computing device 102. The continuous integration system 112 (e.g., POW verification module 118 thereof) may determine 454, using one or more analytical models if the source code update indication satisfies one or more bypass thresholds. The continuous integration system 112 may execute a baseline source code integration workflow or a modified source code integration workflow based on the bypass threshold(s) satisfied by the proof of work data object 422.

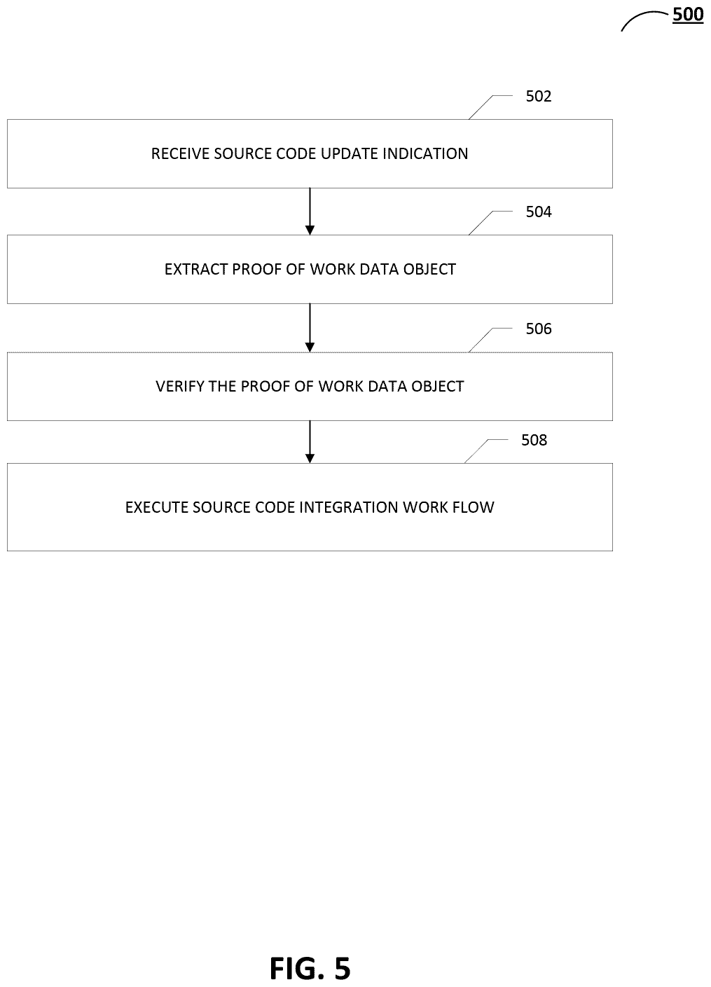

FIG. 5 is a flowchart diagram of an example process 500 for software development and revision management in accordance with at least some embodiments of the present disclosure. The process 500 may be implemented by one or more computing devices, entities, and/or systems described herein.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes at step/operation 502, receiving a source code update indication (e.g., pull request) associated with a source code update identified for merger to a shared source code repository and originating from a local source code repository. For example, the apparatus 200 may receive a source code update indication corresponding to a source code revision originating from a local source code repository. In some embodiments, receiving the source code update indication comprises receiving an event descriptor indicating a change to a branch of the shared source code repository.

The source code update indication may be associated with a proof of work data object. The proof of work data object may be generated based on one or more tests (e.g., one or more proof of work tests) performed on the software code update in a local source code build environment using a local build container.

In some embodiments, the process 500 includes at step/operation 504, extracting the proof of work data object. For example, the apparatus 200 may extract the proof of work data object associated with the source code update indication (e.g., source code revision pushed to a shared source code repository).

In some embodiments, the process 500 includes at step/operation 506, verifying the proof of work data object. For example, the apparatus 200 may verify the proof of work data object.

In some embodiments, verifying the proof of work data object comprises authenticating the proof of work data object based on a cryptographic signature associated with the proof or work data object. In some embodiments, verifying the proof of work data object comprises determining whether the proof of work data object satisfies one or more bypass thresholds. For example, the apparatus may apply one or more cryptographic algorithms to the proof of work data object or associated metadata (e.g., cryptographic signature) to authenticate the proof of work data object (e.g., to verify the authenticity and/or integrity of the proof of work data object). In some embodiments, in response to verifying the authenticity of the proof of work data object, the apparatus 200 (e.g., using one or more analytical models) may determine if the proof of work data object satisfies the one or more bypass thresholds. For example, the apparatus 200 may determine if the proof of work data object satisfies one or more bypass thresholds associated with a baseline source code integration workflow based on application of one or more analytical models. In some embodiments, the one or more analytical models may comprise one or more AI/ML models. Alternatively or additionally, the apparatus 200 may leverage one or more expert systems to determine if the proof of work data object satisfies the one or more bypass thresholds. In some embodiments, the apparatus 200 may associate the source code update with a corresponding bypass flag in response to determining that the proof of work data object satisfies at least one of the one or more bypass thresholds.

In some embodiments, the one or more bypass thresholds are configurable and/or adjustable. For example, the one or more bypass thresholds may be based or otherwise configured based on context associated with the source code update. For example, the apparatus 200 may determine the one or more bypass thresholds based on a context associated with the source code update (e.g., source code revision) and/or shared source code repository. In some embodiments, the one or more bypass thresholds may be determined or adjusted based on the historic health of the branch being updated, the complexity of the update to the branch, the software developer making the updates, and/or the like. In some embodiment, alternatively or additionally, the one or more bypass thresholds may be determined, and/or adjusted based on a risk level associated with the shared source code repository. For example, the apparatus 200 may determine the one or more bypass thresholds based on a risk level (e.g., risk adverse, cautious, balances, agile, and/or the like) associated with the shared source code repository and/or user(s). For example, the one or more bypass thresholds may be configured based on the amount of risk a development team associated with the shared source code repository indicates.

In some embodiments, the process 500 includes at step/operation 508, executing a source code integration workflow (e.g., baseline source code integration workflow or modified source code integration workflow). For example, the apparatus 200 may execute a source code integration workflow (e.g., baseline source code integration workflow or modified source code integration workflow) in response to the source code update indication (e.g., pull request) and based on the verification result and/or source code update associated with the source code update indication.

In some embodiments, in response to the source code update indication and verification result, a baseline source code integration workflow is executed with respect to the source code update where it is determined that the proof of work data object associated with the source code update does not satisfy any of the one or more bypass thresholds and/or in the event that the source code update is not associated with a proof of work data object. For example, the apparatus 200 may execute a baseline source code integration workflow that includes one or more source code testing steps if the source code update associated with the pull request is not associated with a bypass flag.

In some embodiments, a modified source code integration workflow is executed with respect to the source code update where it is determined that the proof of work data object associated with the source code update satisfies at least one of the one or more bypass thresholds. For example, the apparatus 200 may execute a modified source code integration workflow where it is determined that the proof of work data object satisfies at least one of the one or more bypass thresholds. In some embodiments, the modified source code integration workflow may comprise a version of a baseline source code integration workflow that bypasses at least one source code testing steps associated with the baseline source code integration workflow. In some embodiments, the source code testing steps bypassed may be based on the bypass flag associated with the source code update.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for software code revision control in a federated software platform, the computer-implemented method comprising:
receiving a source code update indication associated with a source code update identified for merger to a shared source code repository, wherein the source code update indication comprises at least a proof of work data object generated based on one or more proof of work tests performed on the source code update in a local source code build environment using a local build container;
determining if the proof of work data object satisfies one or more bypass thresholds associated with a baseline source code integration workflow based on application of one or more analytical models; and
in response to determining that the proof of work data object satisfies at least one bypass threshold of the one or more bypass thresholds, executing a modified source code integration workflow, wherein the modified source code integration workflow bypasses at least one step of the baseline source code integration workflow.

2. The computer-implemented method of claim 1, wherein receiving the source code update indication comprises receiving an updated branch of a local source code repository, wherein the local source code repository comprises a copy of the shared source code repository.

3. The computer-implemented method of claim 2, further comprising:
generating the local build container based on a container template of one or more container templates in response to a branching event associated with the local source code repository.

4. The computer-implemented method of claim 1, wherein the at least one step comprises a source code testing step of the baseline source code integration workflow.

5. The computer-implemented method of claim 1, wherein the proof of work data object comprises at least test results summary for the one or more proof of work tests.

6. The computer-implemented method of claim 1, wherein the proof of work data object is associated with one or more cryptographic signatures.

7. The computer-implemented method of claim 6, further comprising:
authenticating the proof of work data object based on the one or more cryptographic signatures.

8. The computer-implemented method of claim 1, further comprising:
determining the one or more bypass thresholds based on a risk level associated with the shared source code repository.

9. The computer-implemented method of claim 1, wherein the one or more analytical models comprise one or more artificial intelligence algorithms.

10. The computer-implemented method of claim 9, further comprising:
determining the one or more bypass thresholds based on a context associated with the source code update.

11. An apparatus for software code revision control in a federated software platform, the apparatus comprising at least one processor and at least one memory including program code, the at least one memory and the program code configured to, with the at least one processor, cause the apparatus to at least:
receive a source code update indication associated with source code update identified for merger to a shared source code repository;
determine if the source code update indication comprises a proof of work data object that satisfies at least one bypass threshold of one or more bypass thresholds associated with a baseline source code integration workflow; and
in response to determining that the proof of work data object satisfies the at least one bypass threshold, execute a modified source code integration workflow, wherein the modified source code integration workflow bypasses at least one step of the baseline source code integration workflow.

12. The apparatus of claim 11, wherein receiving the source code update indication comprises receiving an updated branch of a local source code repository, wherein the local source code repository comprises a copy of the shared source code repository.

13. The apparatus of claim 12, further comprising:
generating a local build container based on a container template of one or more container templates in response to a branching event associated with the local source code repository.

14. The apparatus of claim 11, wherein the at least one step comprises a source code testing step of the baseline source code integration workflow.

15. The apparatus of claim 11, wherein the proof of work data object comprises at least test results summary for one or more proof of work tests performed based on the source code update.

16. The apparatus of claim 11, wherein the proof of work data object is associated with one or more cryptographic signatures.

17. The apparatus of claim 16, further comprising:
authenticating the proof of work data object based on the one or more cryptographic signatures.

18. The apparatus of claim 11, further comprising:
determining the one or more bypass thresholds based on a risk level associated with the shared source code repository.

19. The apparatus of claim 11, wherein determining if the source code update indication comprises the proof of work data object that satisfies the at least one bypass threshold comprises applying one or more analytical models to the proof of work data object.

20. At least one non-transitory computer-readable storage medium for software code revision control in a federated software platform, the at least one non-transitory computer-readable storage medium having computer coded instructions configured to, when executed by at least one processor:
extract a proof of work data object associated with a source code update identified for merger to a shared source code repository, wherein the proof of work data object is generated based on one or more proof of work tests performed on the source code update in a local source code build environment using a local build container;
determine if the proof of work data object satisfies one or more bypass thresholds associated with a baseline source code integration workflow based on application of one or more analytical models; and
in response to the proof of work data object satisfying at least one bypass threshold of the one or more bypass thresholds, execute a modified source code integration workflow that bypasses at least one step of the baseline source code integration workflow.
